(19) United States
(12) Patent Application Publication
(10) Pub. No.: US 2013/0167313 A1
(43) Pub. Date: Jul. 4, 2013

(54) WHITEBOARD ERASER

(71) Applicant: Julie McKenzie, Lynchburg, VA (US)

(72) Inventor: Julie McKenzie, Lynchburg, VA (US)

(21) Appl. No.: 13/574,446

(22) PCT Filed: Jan. 20, 2011
(86) PCT No.: PCT/US11/21882

§ 371 Date: Mar. 20, 2013

Related U.S. Application Data
(60) Provisional application No. 61/296,498, filed on Jan. 20, 2010.

(51) Int. Cl. B43L 21/00

(52) U.S. Cl. CPC B43L 21/00
USPC 15/209.1

(57) ABSTRACT

A whiteboard eraser including a cleaning head, a handle attached to the cleaning head, a soft pad attached to the cleaning head, and a fabric holder configured to attach a fabric to the cleaning head.

This application is based upon and claims the benefit of priority from U.S. Provisional Application No. 61/296,498, filed Jan. 20, 2010, the disclosure of which is incorporated herein in their entirety by reference.

### TECHNICAL FIELD

The present invention relates to an eraser for removing the markings on a non-porous writing surface. More specifically, to an eraser for removing the ink from a dry erase marker on a whiteboard.

### BACKGROUND OF THE INVENTION

The use of dry erase markers on a whiteboard is a popular means of conveying information in a classroom or meeting. Many types of markers are used for writing on a whiteboard. Dry erase marker ink dries on the surface of a whiteboard leaving a thin film. The erasers used for removing the dried ink have been similar in size and shape to conventional chalkboard erasers with a variety of materials such as felt or cloth-like material. One of the main problems with known erasers is the dry erase marker residue collects on the surface of the eraser and degrades the cleaning ability thus making the erase process quite messy.

Chalkboard erasers are difficult to clean so previous inventions have developed erasers with stacked fabric layers which are fastened to a jacket cover over a central core. The Frazier patent U.S. Pat. No. 4,937,910 discloses an eraser surface that is composed of a plurality of fabric layers. When an outer fabric becomes dirty, tabs at the ends of the eraser are used to remove the outer fabric layer and the next layer is revealed. When the last layer of fabric is used the eraser is discarded. The Liu patent U.S. Pat. No. 6,793,430 discloses a multi-functional eraser with a wiping cloth wrapped around a magnetic element. When the cloth becomes dirty, it can be replaced.

There remains a need for an improved eraser that efficiently cleans a whiteboard and provides easy and economical replacement of the cleaning fabric material.

### SUMMARY OF THE INVENTION

This invention develops an efficient whiteboard eraser. In a preferred embodiment, this product includes the cleaning head with an attached handle and easily replaceable disposable cleaning fabric, such as the Swiffer™ fabric available from Procter & Gamble Company. The top and/or sides of the cleaning head contain flexible gripper tabs that allow the cleaning fabric to be easily attached and removed.

An embodiment of the whiteboard eraser includes a cleaning head, a handle attached to the cleaning head, a soft pad attached to the cleaning head, and a fabric holder configured to attach a fabric to the cleaning head, wherein the handle does not move with respect to the cleaning head.

In another embodiment of the invention, the handle is integrally formed with the cleaning head.

In another embodiment of the invention, the handle is removable from the cleaning head.

In another embodiment of the invention, the eraser includes a plurality of fabric holders.

In another embodiment of the invention, the fabric holder includes a fabric gripper.

In another embodiment of the invention, the soft pad is a closed cell foam with a waffle-like surface.

In another embodiment of the invention, the eraser includes a spray bottle attached to the handle.

In another embodiment of the invention, the fabric holder comprises a Velcro® hook type material.

The principal object of the invention is a white board eraser consisting of a cleaning head, handle and a disposable cleaning sheet fabric to remove ink dust and condition the surface of a white board.

A further object of the invention is to provide a white board eraser that is simple to construct but sturdy, economical and long lasting in use.

A further object of the invention is to provide flexible grippers in the cleaning head that allows easy attachment and removal of the disposable cleaning sheet fabric.

A further object of the invention is to provide a soft waffle-like pad in the cleaning head to hold the cleaning sheet fabric in place while erasing a white board.

A further object of the invention is to provide a white board eraser that can be used without user contact with soiled eraser surfaces.

Other objects and features of the invention will be apparent from the description and claims.

### BRIEF DESCRIPTION OF THE DRAWINGS

The foregoing and other objects, aspects and advantages of the invention will be better understood from the following drawings of the invention in which:

FIG. 1 is a top plan view of the eraser 100 thereof including the cleaning head, handle and fabric grippers;

FIG. 2 is a bottom plan view of the eraser 100 thereof showing the soft pad with waffle-like surface.

FIG. 3 is a right side elevational view of the eraser (100) thereof, the left side elevational view being a mirror image thereof; and

FIG. 4 is a front elevational view of the eraser (100) thereof, the rear elevational view being a mirror image thereof.

FIGS. 5 and 6 show embodiments that includes a spray bottle.

### DETAILED DESCRIPTION OF THE INVENTION

It is to be understood by persons of ordinary skill in the art that the following detailed descriptions are provided for purposes of illustration and not for limitation. An artisan understands there are variations that lie within the spirit of the invention and the scope of the appended claims. Unnecessary detail of known functions and operations may be omitted from the current description so as not to obscure the present invention.

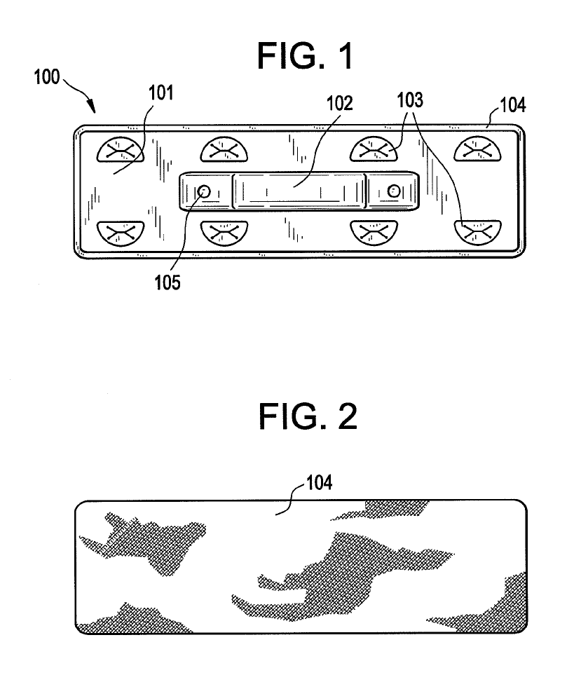

The present invention provides a whiteboard eraser 100, as shown in FIG. 1. The cleaning head 101 includes a rectangular frame made from plastic or similar low cost material. The large handle 102 is contoured to provide ease of use with one hand without having to grasp the cleaning head. The handle 102 is fabricated from plastic or similar low cost material and is attached to the cleaning head 101 using fasteners 105, such as screws, at each end. In this embodiment, the handle is fixedly attached to the frame such that the handle does not move with respect to the cleaning head. In addition, the handle 102 could also be integrally formed with the cleaning head.

Multiple fabric grippers 103 are embedded in the surface of the cleaning head 101 to provide easy attachment of the cleaning fabric and hold it in place. In a preferred embodiment there arc eight individual grippers on the top surface of the cleaning head 101 with four on each side as shown in FIG. 1. However, the number of grippers may vary depending on the size and shape of the cleaning head 101.

A soft pad 104 is attached to the bottom of the cleaning head 101 as shown in FIG. 2. The pad is fabricated using a closed cell foam with waffle-like surface to hold the cleaning sheet fabric in place and provide wells to hold the dry erase marker ink.

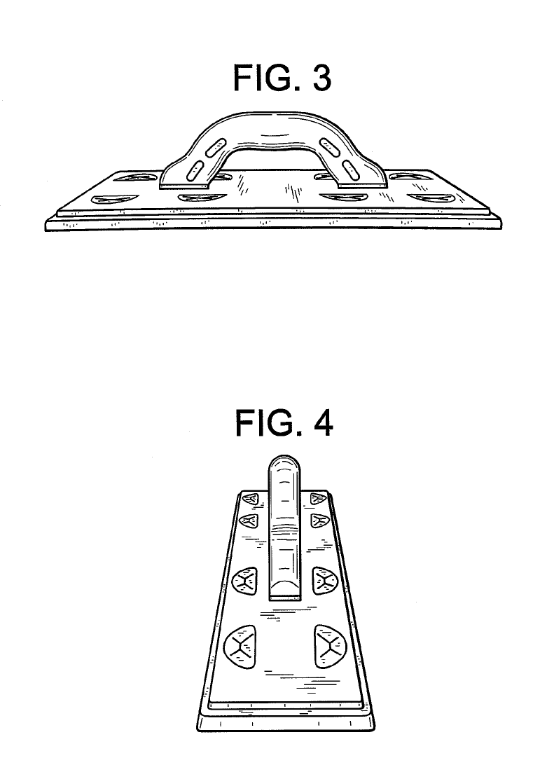

In a preferred embodiment, the cleaning head is a rectangular shape that is easily fabricated as shown in FIG. 3 and FIG. 4. However, multiple shapes and sizes can be designed to match a white board or create a unique style, such as a circle or oval.

In a preferred embodiment, the soft pad 104 is a closed cell foam with waffle-like surface. However, it may be fabricated from other soft material such as a sponge for applications where a wet cleaning sheet fabric is preferred.

In a preferred embodiment, the fabric grippers 103 are fabricated using soft rubber or plastic flexible tabs. However, it may be fabricated from a Velcro® hook type material which provides easy attachment and removal of a cleaning sheet.

A removable handle option may be provided to allow multiple handle shapes for ease of use and to create a unique style. For example, wing nuts could be used to secure the handle to the cleaning head.

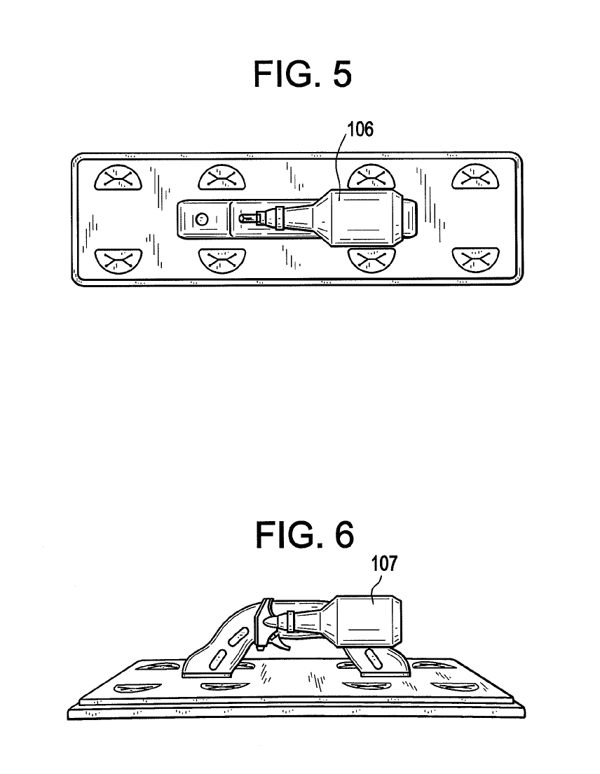

An optional spray bottle container may be provided as an attachment to allow wetting of the white board surface while erasing the dry marker ink. Embodiments with spray bottles 106 and 107 attached to the handle 102 are shown in FIGS. 5 and 6.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. An eraser comprising:
a cleaning head;
a handle attached to said cleaning head;
a soft pad attached to said cleaning head; and
a fabric holder configured to attach a fabric to said cleaning head;
wherein said handle does not move with respect to the cleaning head.

2. The eraser of claim 1, wherein said handle is integrally formed with said cleaning head.

3. The eraser of claim 1, wherein said handle is removable from said cleaning head.

4. The eraser of claim 1, further comprising a plurality of fabric holders.

5. The eraser of claim 1, wherein said fabric holder comprises a fabric gripper.

6. The eraser of claim 1, wherein the soft pad is a closed cell foam with a waffle-like surface.

7. The eraser of claim 1, further comprising a spray bottle attached to said handle.

8. The eraser of claim 1, wherein said fabric holder comprises a Velcro® hook type material.
